(19) United States
(12) Patent Application Publication
(10) Pub. No.: US 2005/0285527 A1
(43) Pub. Date: Dec. 29, 2005

(54) Plasma display panel

(76) Inventors: Jae-lk Kwon, Suwon-si (KR); Kyu-Hang Lee, Suwon-si (KR); Jung-Keun Ahn, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/158,519

(22) Filed: Jun. 22, 2005

(30) Foreign Application Priority Data
Jun. 23, 2004 (KR) 10-2004-0046939

(51) Int. Cl. H01J 17/49

(52) U.S. Cl. 313/583; 313/585; 313/584

(57) ABSTRACT

Provided is a plasma display panel that can generate stable discharge and can be manufactured in a simple process. The plasma display panel includes a rear substrate, a front substrate disposed apart from the rear substrate, a plurality of barrier ribs that define discharge cells together with the rear substrate and the front substrate and disposed between the rear substrate and the front substrate, sustain electrode pairs extended across the discharge cells, address electrodes extended across the discharge cells to cross the sustain electrodes, a first dielectric layer that covers the sustain electrode, a second dielectric layer that covers the address electrodes, fluorescent layers disposed in the discharge cells, and a discharge gas filled in the discharge cells, wherein the sustain electrode comprises a first electrode unit disposed in a direction crossing the address electrode, a second electrode unit disposed apart from the first electrode unit toward the central portion of the discharge cell, a third electrode unit disposed apart from the second electrode unit toward the inside of the discharge cell, and a fourth electrode unit that connect the first electrode unit, the second electrode unit, and the third electrode unit for each discharge cell, and the second electrode unit is formed to concave in a direction facing the inside of the discharge cells.

### CROSS-REFERENCE TO RELATED PATENT APPLICATION

This application claims the benefit of Korean Patent Application No. 10-2004-0046939, filed on Jun. 23, 2002, in the Korean Intellectual Property Office, the disclosure of which is incorporated herein in its entirety by reference.

### BACKGROUND OF THE INVENTION

1. Field of the Invention

The present invention relates to a display technology, and more particularly, to a plasma display panel.

2. Description of the Related Technology

Recently, plasma display panel (PDP) devices have drawn great attention as devices for replacing conventional cathode ray tubes (CRT). PDPs create a visible image by exciting a fluorescent material formed in a discharge cell by generating a plasma discharge and resulting ultraviolet radiation in the discharge cell.

PDP devices can be categorized into direct current and alternate current types according to the type of voltage applied to the discharge cell. In the direct current type PDP devices, electrons move directly between discharge electrodes exposed in the discharge cell. In the alternate current type PDP devices, on the other hand, at least one electrode is coated with a dielectric layer and the plasma discharge occurs without direct migration of charged particles between the electrodes.

In the direct current type PDP devices, discharge electrodes are often severely damaged because charged particles directly contact and collide with the electrodes. For this reason, recently alternate current type devices, particularly those employing three discharge electrodes are more common.

FIG. 1 is a cutaway exploded perspective view of a conventional PDP device 10. Referring to FIG. 1, the PDP device 10 comprises an upper plate 50 and a lower plate 60. A plurality of sustain electrode pairs 12, each of which includes an X electrode 31 and a Y electrode 32, are formed on a front substrate 11. A plurality of address electrodes 22 are disposed on a rear substrate 21 of the lower plate and extend in a direction generally perpendicular to the X and Y electrodes 31 and 32.

A first dielectric layer 15 buries the sustain electrode pairs 12, and a second dielectric layer 25 buries the address electrodes 22.

A protection layer 16 (typically MgO) is formed on the first dielectric layer 15 facing discharge cells 70. A plurality of barrier ribs 30 are formed on the second dielectric layer 25 and define the discharge cells 70. The barrier ribs 30 prevent electrical and optical cross talk between the discharge cells 70 and maintain a discharge distance. Fluorescent materials of red, green, and blue color are coated on both sides of the barrier ribs 30 and on a front surface of the second dielectric layer 25 where the barrier ribs 30 are not formed.

The X electrode 31 and the Y electrode 32 respectively include transparent electrodes 31a and 32a and bus electrodes 31b and 32b. A space formed by the pairs of the X and Y electrodes 31 and 32 and the address electrodes 22 crossing the X and Y electrodes 31 and 32 is a unit discharge cell 70 which forms a discharge unit. The transparent electrodes 31a and 32a are made of a transparent conductive material that does not interrupt the progress of light generated from a fluorescent layer 26 toward the front substrate 11. The transparent conductive material can be indium tin oxide (ITO). However, transparent conductive materials including ITO are generally less conductive than highly conductive metals such as copper or aluminum. Thus, if the sustain electrodes are formed using only transparent electrodes 31a and 32a, the driving power of the device increases due to a large voltage drop along the length of the transparent electrodes 31a and 32a. Also, the circuit's response time is delayed. To solve this problem, narrow bus electrodes 31b and 32b formed of a more conductive metal are connected to the transparent electrodes 312b and 313b.

However, the construction employing both bus electrodes and transparent electrodes requires high manufacturing costs since the transparent electrode materials are expensive and more process steps are involved in the manufacturing of the bus electrodes and transparent electrodes.

### SUMMARY OF CERTAIN INVENTIVE ASPECTS

The present invention provides a PDP having sustain electrodes that can generate a stable discharge and can be manufactured in a simple manufacturing process.

According to an aspect of the present invention, there is provided a plasma display panel comprising: a rear substrate; a front substrate disposed apart from the rear substrate; a plurality of barrier ribs that define discharge cells together with the rear substrate and the front substrate and disposed between the rear substrate and the front substrate; sustain electrode pairs extended across the discharge cells; address electrodes extended across the discharge cells to cross the sustain electrodes; a first dielectric layer that covers the sustain electrode; a second dielectric layer that covers the address electrodes; fluorescent layers disposed in the discharge cells; and a discharge gas filled in the discharge cells, wherein the sustain electrode comprises a first electrode unit disposed in a direction crossing the address electrode, a second electrode unit disposed apart from the first electrode unit toward the inside of the discharge cell, a third electrode unit disposed apart from the second electrode unit toward the inside of the discharge cell, and a fourth electrode unit that connect the first electrode unit, the second electrode unit, and the third electrode unit in each discharge cell, and the second electrode unit is formed to concave in a direction facing the inside of the discharge cells.

According to another aspect of the present invention, there is provided a plasma display panel comprising: a rear substrate; a front substrate disposed apart from the rear substrate; a plurality of barrier ribs that define discharge cells together with the rear substrate and the front substrate and disposed between the rear substrate and the front substrate; sustain electrode pairs extended across the discharge cells; address electrodes extended across the discharge cells to cross the sustain electrodes; a first dielectric layer that covers the sustain electrodes; a second dielectric layer that covers the address electrodes; fluorescent layers disposed in the discharge cells; and a discharge gas filled in the discharge cells, wherein the sustain electrode comprises a first electrode unit disposed in a direction crossing the address electrodes, a second electrode unit disposed apart from the first electrode unit toward the inside of the discharge cell, a third electrode unit disposed apart from the first electrode unit toward the opposite direction to the second electrode unit, and a fourth electrode unit that connect the first electrode unit, the second electrode unit, and the third electrode unit in each discharge cell, and the second electrode unit is formed to convex in a direction facing the inside of the discharge cells.

According to the present invention, the stability of discharge and luminous efficiency of the plasma display panel can be improved since electrodes are formed to diffuse the discharge efficiently among the electrodes. Also, the manufacturing cost can be reduced and the manufacturing process can be simplified since the electrodes are formed of the same material.

### BRIEF DESCRIPTION OF THE DRAWINGS

The above and other features and advantages of the present invention will become more apparent by describing in detail exemplary embodiments thereof with reference to the attached drawings in which:

FIG. 1 is a cutaway exploded perspective view of a conventional PDP;

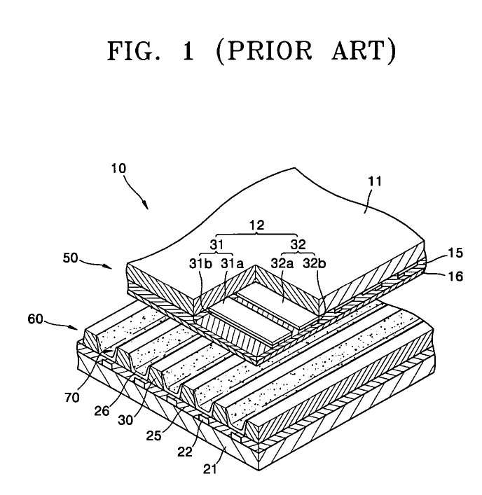

FIG. 2 is a cross-sectional view illustrating a discharge cell, in which an upper plate is rotated 900, of the PDP of FIG. 1;

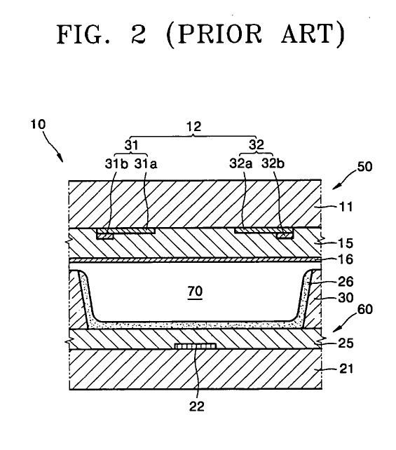

FIG. 3 is a cutaway exploded perspective view of a PDP according to a first embodiment of the present invention;

FIG. 4 is a plan view of the shape of the barrier ribs and sustain electrodes of FIG. 3;

FIG. 5 is a plan view, which corresponds to the plan view of FIG. 4, of a modified version of the PDP according to the first embodiment of the present invention;

FIG. 6 is a cutaway exploded perspective view of a PDP according to a second embodiment of the present invention;

FIG. 7 is a plan view of the shape of the barrier ribs and sustain electrodes of FIG. 6; and

FIG. 8 is a plan view, which corresponds to the plan view of FIG. 7, of a modified version of the PDP according to the second embodiment of the present invention.

### DETAILED DESCRIPTION OF CERTAIN INVENTIVE EMBODIMENTS

Various features of the present invention will now be described more fully with reference to the embodiments illustrated in the accompanying drawings. Each titled first and second embodiment may have additional variations which provide further embodiments.

### First Embodiment

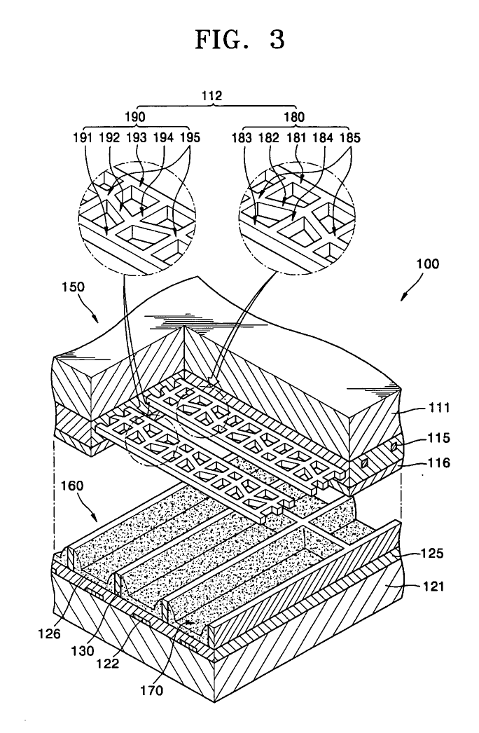

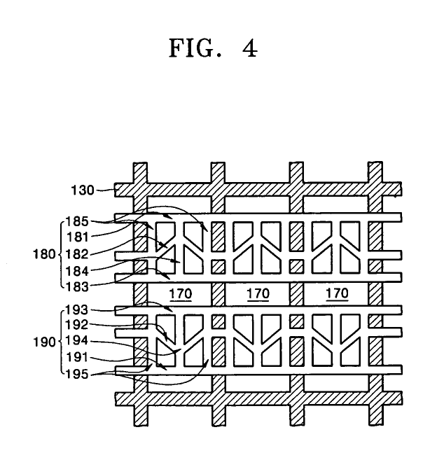

Referring to FIGS. 3 and 4, an alternative type PDP device 100 according to a first embodiment of the present invention is illustrated. A lower plate 160 is coupled parallel to the upper plate 150. More specifically, the PDP 100 comprises a rear substrate 121, a front substrate 111 disposed apart from the rear substrate 121, barrier ribs 130 that define discharge cells 170 together with the front substrate 111 and the rear substrate 121 and disposed between the front substrate 111 and the rear substrate 121, sustain electrode pairs 112 extended across the discharge cells 170, address electrodes 122 extended across the discharge cells 170 to cross the sustain electrode pairs 112, a first dielectric layer 115 that covers the sustain electrode pairs 112, a second dielectric layer 125 that covers the address electrodes 122, fluorescent layers 126 disposed in the discharge cells 170, and a discharge gas filled in the discharge cells 170.

The sustain electrode pairs 112 are disposed on the front substrate 111 of the upper plate 150. At this time, conventionally, the front substrate 111 is formed of a transparent material in which glass is a typical substance.

Each sustain electrode pair 112 denotes a pair of sustain electrodes 180 and 190 formed on a rear surface of the front substrate 111 for generating a discharge, and the sustain electrode pairs 112 are arranged in parallel separated by a predetermined distance from each other on the front substrate 111. Each sustain electrode pair 112 comprises an X electrode 180 and a Y electrode 190.

The X and Y electrodes 180 and 190 respectively includes first electrode units 181 and 191, second electrode units 182 and 192, third electrode units 183 and 193, fourth electrode units 184 and 194, and fifth electrode units 185 and 195.

The adjacent first electrode units (or substantially linear elements) 181 and 191 are connected to each other and extended across the discharge cells 170. The second electrode units (or undulating elements) 182 and 192 disposed in the discharge cells 170 are disposed a predetermined distance from each other and parallel to each other from the first electrode units 181 and 191 toward the inside of the discharge cells 170, and the third electrode units (or substantially linear elements) 183 and 193 are disposed parallel to each other from the second electrode units 182 and 192 toward the inside of the discharge cells 170. At this time, the second electrode units 182 and 192 and the third electrode units 183 and 193 included in each sustain electrodes 180 and 190 respectively are connected to each other and extended across the discharge cells 170.

The fourth electrode units (or interconnecting elements) 184 and 194 for respectively connecting the first electrode units 181 and 191, the second electrode units 182 and 192, and the third electrode units 183 and 193 are disposed for each discharge cell 170. The fourth electrode units 184 and 194 are disposed substantially vertically to the first electrode units 181 and 191 and the third electrode units 183 and 193.

The second electrode units 182 and 192 are formed to concave in a direction facing the inside of the discharge cells 170. As depicted in FIG. 4, the second electrode units 182 and 192 have a “V” shaped cross-sectional surface.

In the PDP 100 according to the first embodiment, the sustain electrodes 180 and 190 can further include a pair of fifth electrode units (or interconnecting elements) 185 and 195 that connect the first electrode units 181 and 191 and the third electrode units 183 and 193, the fifth electrode units 185 and 195 are disposed substantially parallel to the fourth electrode units 184 and 194 at left and right sides of the fourth electrode units 184 and 194 in each discharge cell 170. The fifth electrode units 185 and 195 are formed perpendicularly with respect to the first electrode units 181 and 191 and the third electrode units 183 and 193.

The first through fifth electrode units 181, 182, 183, 184, 185, 191, 192, 193, 194, and 195 are respectively formed in one body using a metal having a narrow width to increase an aperture ratio toward the front direction. At this time, the first through fifth electrode units 181, 182, 183, 184, 185, 191, 192, 193, 194, and 195 can be formed of different materials, but it is desirable to use an identical material for simplifying the manufacturing process. Also, the second through fifth electrode units 182, 183, 184, 185, 192, 193, 194, and 195 can be respectively formed in one body using a transparent material such as ITO and the first electrode units 181 and 191 can be formed using a metal such as Cu or Al. In this case, the first electrode units 181 and 191 can be used as the bus electrodes.

The first, second, third, fifth electrode units 181, 182, 183, 185, 191, 192, 193, and 195 can be respectively formed symmetrically with respect to the fourth electrode units 184 and 194 for generating a stable discharge.

Referring again to FIG. 3, the address electrodes 122 are formed to cross the X electrode 180 and the Y electrode 190 on the rear substrate 121 facing a surface of the front substrate 111.

The address electrodes 122 are formed to generate an address discharge which facilitates a sustain discharge between the X electrode 180 and the Y electrode 190. More specifically, the address electrodes 122 reduce a discharge voltage for generating the sustain discharge. The address discharge occurs between the Y electrode 190 and the address electrode 122. When the address discharge is completed, positive ions are accumulated on the Y electrode 190 and electrons are accumulated on the X electrode 180, thereby facilitating the sustain discharge between the X electrode 180 and the Y electrode 190.

A space formed by a pair of the X electrode 180 and the Y electrode 190 and the address electrodes 122 crossing the X and Y electrodes 180 and 190 forms a unit discharge cell 170.

A first dielectric layer 115 covering the sustain electrode pairs 112 is formed on the front substrate 111. The first dielectric layer 115 is formed of a dielectric that can prevent a direct electric communication between the X electrode 180 and the adjacent Y electrode 190 during the sustain discharge, can prevent the damaging of the X electrode 180 and the Y electrode 190 by the direct collision between positive ions or electrons with the sustain electrodes 180 and 190, and can accumulate wall charge by inducing the charges. The dielectric can be PbO, B₂O₃, or SiO₂, for example.

Also, a protection layer 116 conventionally formed of MgO is formed on the first dielectric layer 115. The protection layer 116 prevents the damaging of the first dielectric layer 115 from collision with positive ions or electrons during discharging, has high light transmittance, and generates a lot of secondary electrons.

A second dielectric layer 125 covering the address electrodes 122 is formed on the rear substrate 121. The second dielectric layer 125 is formed of a dielectric that can prevent the damaging of the address electrodes 122 by colliding with positive ions or electrons during discharging and can induce electrons. The dielectric can be PbO, B₂O₃, or SiO₂, for example.

Barrier ribs 130 that maintain a discharge distance and prevent electrical and optical cross talk between the adjacent discharge cells 170 are formed between the first dielectric layer 115 and the second dielectric layer 125.

In FIG. 3, the barrier ribs 130 are partitioned in a matrix shape in the discharge cell 170, but the present invention is not limited thereto, and, as long as a plurality of discharge cells can be formed, the barrier ribs 130 can be formed in various shapes such as an opened type barrier ribs shape such as a stripe and a closed type barrier ribs shape such as a waffle, a matrix, or a delta, for example. Also, a cross-sectional surface of the closed type barrier ribs can be a polygon such as a triangle, a pentagon, or a rectangular as in the present embodiment, or a circle or an oval, for example.

The fluorescent layers 126 of red, green, and blue color are coated on both sides of the barrier ribs 130 and on a front surface of the second dielectric layer 125 on which the barrier ribs 130 are not formed.

The fluorescent layer 126 contains a material that generates visible light by receiving ultraviolet rays. In one embodiment, the fluorescent layer 126 formed in a sub-pixel that generates red light includes a fluorescent material such as Y(V,P)O₄:Eu, the fluorescent layer 126 formed in a sub-pixel that generates green light includes a fluorescent material such as Zn₂SiO₄:Mn, or YBO₃:Tb, and the fluorescent layer 126 formed in a sub-pixel that generates blue light includes a fluorescent material such as BAM:Eu.

In one embodiment, a gas selected from gases of Ne, He, Xe, and a gas mixture of these gases is used to fill in the discharge cell 170 and sealed.

The operation of the PDP 100 will now be described.

An address discharge is generated by applying an address voltage between the address electrodes 122 and the Y electrode 190. As a result of the address discharge, a discharge cell 170, in which a sustain discharge will generate, is selected.

Afterward, when a sustain discharge voltage is applied between the X electrode 180 and the Y electrode 190 of the selected discharge cell 170, a sustain discharge is generated by colliding the positive ions accumulated on the Y electrode 190 with the electrons accumulated on the X electrode 180, and the discharge is continued by applying a voltage alternately between the X electrode 180 and the Y electrode 190.

However, when the sustain discharges are generated between the X electrode 180 and the Y electrode 190, the discharge initiates between the third electrode units 183 and 193 which have the smallest discharge gap and the discharge diffuses to the second electrode units 182 and 192 and the first electrode units 181 and 191. At this time, the discharge rapidly diffuses from the third electrode units 183 and 193 to the second electrode units 182 and 192 since the discharge is actively generated at an adjacent portion to the third electrode units 183 and 193.

However, the prompt diffusion from the second electrode units 182 and 192 to the first electrode units 181 and 191 may be difficult since the region between the second electrode units 182 and 192 and the first electrode units 181 and 191 is far from the discharge center. Therefore, the electrodes must be formed to secure a stable diffusion from the second electrode units 182 and 192 to the first electrode units 181 and 191. In the PDP 100 according to the first embodiment, the second electrode units 182 and 192 are formed in a concave shape focused toward the inside of the discharge cells 170. That is, a distance between the second electrode units 182 and 192 and the first electrode units 181 and 191 is the nearest at the center portion of the discharge space on which the fourth electrode units 184 and 194 are formed and the distance gradually increases as it progresses towards the left and right side portions of the discharge space. Accordingly, when the discharge diffuses from the second electrode units 182 and 192 to the first electrode units 181 and 191, the discharge diffuses firstly at the central portion of the discharge space where the discharge occurs actively and the distance between the second electrode units 182 and 192 and the first electrode units 181 and 191 is the nearest and then the discharge diffuses on both side portions of the discharge space. Therefore, stable discharge diffusion can be achieved by the concave shape of the second electrode units 182 and 192 without reducing the distance between the second electrode units 182 and 192 and the first electrode units 181 and 191.

Ultraviolet rays are generated from a discharge gas by reducing the energy level of the discharge gas which is excited during discharging. The ultra violet rays excite the fluorescent layer 126 coated in the discharge cells 170, and visible light is generated by reducing the energy level of the fluorescent layer 126, and then, the emitted visible light displays an image.

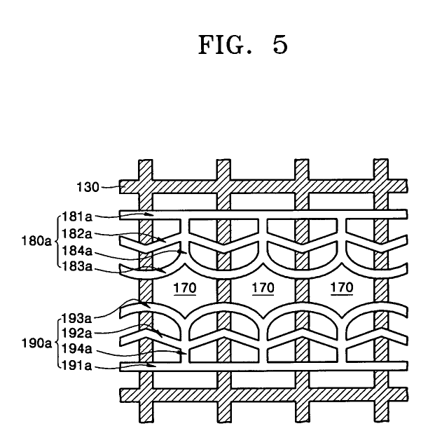

FIG. 5 is a plan view of a modified version of the PDP according to the first embodiment of the present invention. FIG. 5 shows the shapes of the barrier ribs 130 and sustain electrodes 180a and 190a corresponding to the barrier ribs 130 and the sustain electrodes 180 and 190 of FIG. 4. One sustain electrode 180a includes first through fourth electrode units 181a, 182a, 183a, and 184a and the other sustain electrode 190a includes first through fourth electrode units 191a, 192a, 193a, and 194a. Here, to facilitate understanding, identical reference numerals have been used, where possible, to designate identical elements that are common to the previous figures and components are similar or identical to the components employed in the previous drawings except the third electrode units 183a and 193a.

Referring to FIG. 5, the third electrode units 183a and 193a having a predetermined curvature are respectively formed to extend to left and right sides of the fourth electrode units 184a and 194a. The third electrode units 183a and 193a have a convex shape directed toward the inside of the discharge cells 170 unlike in the first embodiment in which the third electrode units 183 and 193 are formed to parallel to the first electrode units 181 and 191 and the second electrode units 182 and 192. Therefore, the discharge is effectively generated since space charges are gathered in the center of the discharge cells 170 by the third electrode units (undulating elements) 183a and 193a corresponding to each other during discharging. Also, the discharge is stably diffused from the second electrode units (or undulating elements) 182a and 192a to the first electrode units (substantially linear elements) 181a and 191a due to the convex of the second electrode units 182a and 192a like in the first embodiment.

### Second Embodiment

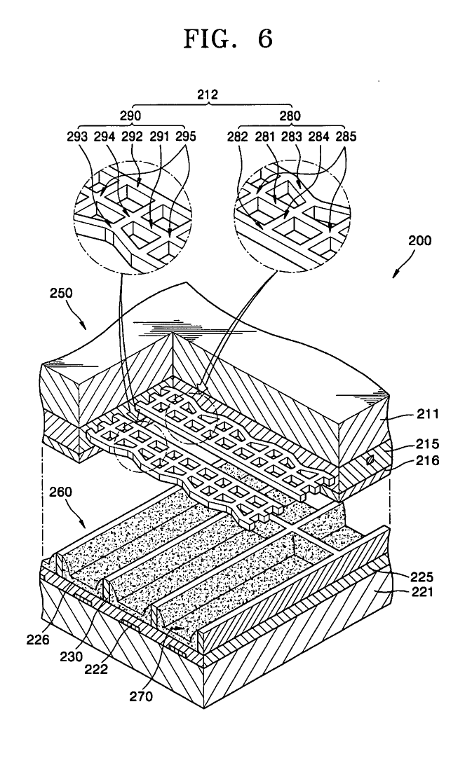

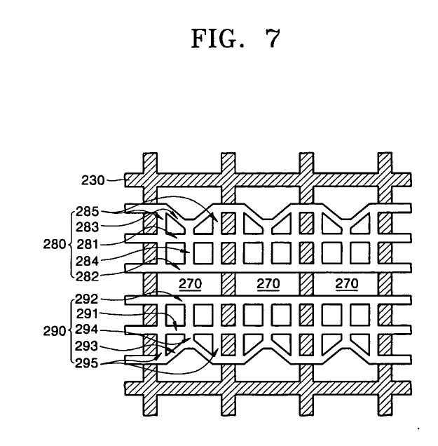

FIG. 6 is a cutaway exploded perspective view of a PDP 200 according to a second embodiment of the present invention and FIG. 7 is a plan view of the shape of the barrier ribs and sustain electrodes of FIG. 6.

Referring to FIGS. 6 and 7, the PDP 200 comprises an upper plate 250 and a lower plate 260. More specifically, the PDP 200 comprises a rear substrate 221, a front substrate 211 disposed apart from the rear substrate 221, barrier ribs 230 that define discharge cells 270 together with the front substrate 211 and the rear substrate 221 and disposed between the front substrate 211 and the rear substrate 221, sustain electrode pairs 212 extended across the discharge cells 270, a plurality of address electrodes 222 extended across the discharge cells 270 to cross the sustain electrode pairs 212, a first dielectric layer 215 that covers the sustain electrode pairs 212, a second dielectric layer 225 that covers the address electrodes 222, fluorescent layers 226 disposed in the discharge cells 270, and a discharge gas filled in the discharge cells 270. The PDP 200 can further include a protection layer 216 formed of MgO, for example, on the first dielectric layer 215.

The descriptions of the structures and functions of the rear substrate 221, the front substrate 211, the address electrodes 222, the first dielectric layer 215, the second dielectric layer 225, the barrier ribs 230, the protection layer 216, the fluorescent layers 226, and the discharge gas are omitted since the structures and functions of these components are at least similar to the corresponding components in the first embodiment. Hereinafter, the second embodiment, mainly the differences from the first embodiment, will now be described.

The sustain electrode pairs 212 are disposed on the front substrate 211 of the upper plate 250. Each sustain electrode pair 212 for generating a discharge denotes a pair of sustain electrodes 280 and 290 formed on a rear surface of the front substrate 211 and the sustain electrode pairs 212 are arranged in parallel with a predetermined distance from each other. Each sustain electrode pair 212 comprises an X electrode 280 and a Y electrode 290.

The X and Y electrodes 280 and 290 respectively includes first electrode units 281 and 291, second electrode units 282 and 292, third electrode units 283 and 293, fourth electrode units 284 and 294, and fifth electrode units 285 and 295.

The adjacent first electrode units (or substantially linear elements) 281 and 291 are respectively connected to each other and extended across the discharge cells 270. The second electrode units (or substantially linear elements) 282 and 292 disposed in the discharge cells 270 are disposed a predetermined distance from each other and parallel to each other from the first electrode units 281 and 291 toward the inside of the discharge cells 270, and the third electrode units (or undulating elements) 283 and 293 are disposed a predetermined distance from each other and parallel to each other from the second electrode units 182 and 192 toward an opposite direction of the inside of the discharge cells 270. At this time, the second electrode units 282 and 292 and the third electrode units 283 and 293 included in each sustain electrodes 280 and 290 are respectively connected to each other and extended across the discharge cells 270.

The fourth electrode units (or interconnecting elements) 284 and 294 for respectively connecting the first electrode units 281 and 291, the second electrode units 282 and 292, and the third electrode units 283 and 293 are disposed in each discharge cell 270. The fourth electrode units 284 and 294 are disposed substantially vertically to the first electrode units 281 and 291 and the second electrode units 282 and 292.

The third electrode units 283 and 293 are formed to convexly face the inside of the discharge cells 170. As depicted in FIG. 7, adjacent pairs of the third electrode units 283 and 293 have “V” shaped cross-sectional surfaces.

In the PDP 200 according to the second embodiment, the sustain electrodes 280 and 290 can further include a pair of fifth electrode units (or interconnecting elements) 285 and 295 that connect the second electrode units 282 and 292 and the third electrode units 283 and 293, and the fifth electrode units 285 and 295 are disposed substantially parallel to the fourth electrode units 284 and 294 at left and right sides of the fourth electrode units 284 and 294 in each discharge cell 270. The fifth electrode units 285 and 295 are respectively formed perpendicularly to the first electrode units 281 and 291 and the second electrode units 282 and 292.

The first through fifth electrode units 281, 282, 283, 284, 285, 291, 292, 293, 294, and 295 are respectively formed in one body using a metal having a narrow width to increase an aperture ratio toward the front direction. At this time, the first through fifth electrode units 281, 282, 283, 284, 285, 291, 292, 293, 294, and 295 can be respectively formed of different materials, but in one embodiment it is desirable to use an identical material for simplifying the manufacturing process. Also, the first, second, forth, and fifth electrode units 281, 282, 284, 285, 291, 292, 294, and 295 can be respectively formed in one body using a transparent material such as ITO and the third electrode units 283 and 293 can be formed using a metal. In this case, the third electrode units 283 and 293 can be used as the bus electrodes.

The first, second, third, and fifth electrode units 281, 282, 283, 285, 291, 292, 293, and 295 can be respectively formed symmetrically with respect to the fourth electrode units 284 and 294 for generating a stable discharge for each discharge cell 270.

When a discharge is generated between the X electrode 280 and the Y electrode 290, the discharge initiates between the second electrode units 282 and 292 which have the smallest discharge gap and the discharge diffuses consecutively to the first electrode units 281 and 291 and the third electrode units 283 and 293. At this time, the discharge stably diffuses from the second electrode units 282 and 292 to the first electrode units 281 and 291 since the discharge is generated actively near the second electrode units 282 and 292. Accordingly, the diffusion of discharge from the second electrode units 282 and 292 to the first electrode units 281 and 291 is achieved rapidly.

However, the prompt diffusion from the first electrode units 281 and 291 to the third electrode units 283 and 293 may be difficult since the region between the third electrode units 283 and 293 and the first electrode units 281 and 291 is far from the discharge center. Therefore, the electrodes must be formed to secure a stable diffusion from the first electrode units 281 and 291 to the third electrode units 283 and 293. In the PDP 200 according to the second embodiment, the third electrode units 283 and 293 are formed in a convex shape directed toward the inside of the discharge cells 270. That is, a distance between the third electrode units 283 and 293 and the first electrode units 281 and 291 is the nearest at the center portion of the discharge space on which the fourth electrode units 284 and 294 are formed and the distance gradually increases as it proceeds toward the left and right sides of the discharge space. Accordingly, when the discharge diffuses from the first electrode units 281 and 291 to the third electrode units 283 and 293, the discharge diffuses firstly at the central portion of the discharge space where the discharge occurs actively and the distance between the third electrode units 283 and 293 and the first electrode units 281 and 291 is the nearest, and then the discharge diffuses on both sides of the discharge space. Therefore, a stable discharge diffusion can be achieved by the convex shape of the third electrode units 283 and 293 without reducing the distance between the third electrode units 283 and 293 and the first electrode units 281 and 291.

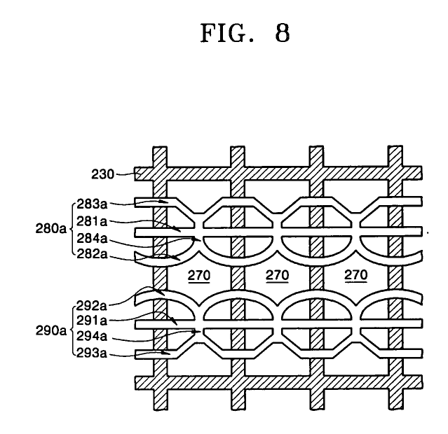

FIG. 8 is a plan view, which corresponds to the plan view of FIG. 7, of a modified version of the PDP according to the second embodiment of the present invention. FIG. 8 shows the shapes of the barrier ribs 230 and sustain electrodes 280a and 290a corresponding to the barrier ribs 230 and the sustain electrodes 280 and 290 of FIG. 7. One sustain electrode 280a includes first through fourth electrode units 281a, 282a, 283a, and 284a and the other sustain electrode 290a includes first through fourth electrode units 291a, 292a, 293a, and 294a. Here, to facilitate understanding, identical reference numerals have been used, where possible, to designate identical elements that are common to the previous figures and components are similar or identical to the components employed in the previous drawings except the second electrode units 282a and 292a.

Referring to FIG. 8, the second electrode units (or undulating elements) 282a and 292a having a predetermined curvature are respectively formed to extend to left and right sides of the fourth electrode units (or interconnecting elements) 284a and 294a. The second electrode units 282a and 292a respectively have a convex shape directed toward the inside of the discharge cells 270 unlike in the embodiment of FIG. 7 in which the second electrode units 282 and 292 are formed to be parallel to the first electrode units 281 and 291. Therefore, the discharge is effectively generated since space charges are gathered in the center of the discharge cells 270 by the second electrode units 282a and 292a corresponding to each other during discharging. Also, the discharge is stably diffused from the first electrode units (or substantially linear elements) 281a and 291a to the third electrode units 283a and 293a due to the convex of the third electrode units (or undulating elements) 283a and 293a similar to the second embodiment.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A plasma display panel, comprising:
a plurality of barrier ribs that define discharge cells;
a plurality of sustain electrode pairs extended across the discharge cells;
a plurality of address electrodes extended across the discharge cells to cross the sustain electrodes; and
wherein each sustain electrode comprises a first electrode unit disposed in a direction crossing the address electrode, a second electrode unit disposed apart from the first electrode unit toward a central portion of the discharge cell, a third electrode unit disposed apart from the second electrode unit toward the central portion of the discharge cell, and a fourth electrode unit that connect the first electrode unit, the second electrode unit, and the third electrode unit in each discharge cell, and
wherein the second electrode unit is formed to be concave in a direction facing the central portion of the respective discharge cell.

2. The plasma display panel of claim 1, further comprising:
a rear substrate;
a front substrate disposed apart from the rear substrate;
wherein the plurality of barrier ribs are located between the front and the rear substrates.

3. The plasma display panel of claim 1, further comprising:
a first dielectric layer that covers the plurality of sustain electrodes;
a second dielectric layer that covers the plurality of address electrodes;
wherein a fluorescent material layer is formed on a surface of each discharge cell; and
wherein a discharge gas filled in each discharge cell.

4. A plasma display panel comprising:
a plurality of barrier ribs that define discharge cells;
a plurality of sustain electrode pairs extended across the discharge cells;
a plurality of address electrodes extended across the discharge cells to cross the sustain electrodes; and
wherein the sustain electrode comprises a first electrode unit disposed in a direction crossing the address electrodes, a second electrode unit disposed apart from the first electrode unit toward a central portion of the discharge cell, a third electrode unit disposed apart from the first electrode unit toward the direction opposite to the second electrode unit, and a fourth electrode unit that connect the first electrode unit, the second electrode unit, and the third electrode unit in each discharge cell, and
the second electrode unit is formed to convex in a direction facing the central portion of the discharge cells.

5. A plasma display panel device, comprising:
an array of a plurality of discharge cells;
a plurality of discharge electrode pairs formed over the array;
wherein at least one of the discharge electrodes comprises a first linear element, a first undulating element and a plurality of interconnecting elements;
wherein the first linear element extends generally in the first direction;
wherein the first undulating element extends along the first linear element generally in the first direction and comprises at least one portion extending in a direction other than the first direction; and
wherein the plurality of interconnecting elements connects the first linear element and the first undulating element.

6. The device of claim 5, wherein the at least one discharge electrode has a plurality of throughholes defined by neighboring elements comprising the first linear element, the first undulating element and at least one interconnecting element.

7. The device of claim 5, wherein at least part of the at least one discharge electrode is made of a substantially non-transparent material.

8. The device of claim 5, wherein each pair of discharge electrode extends over a single discharge cell, and wherein one discharge electrode of the pair has a mirror image configuration of the other discharge electrode.

9. The device of claim 5, wherein the device is operable without a separate bus electrode that has a higher electric conductivity than the discharge electrode.

10. The device of claim 5, wherein the plurality of interconnecting elements mechanically and electrically connects the first linear element and the first undulating element.

11. The device of claim 5, wherein the at least one discharge electrode is substantially equipotential throughout.

12. The device of claim 5, further comprising a second substantially linear element extending along the first linear element generally in the first direction.

13. The device of claim 12, wherein the first undulating element is located between the first and second linear elements.

14. The device of claim 12, wherein the second linear element is located between the first linear element and the first undulating element.

15. The device of claim 5, further comprising a second undulating element extending generally in the first direction and comprising at least one portion extending in a direction other than the first direction.

16. The device of claim 15, wherein at least part of the plurality of interconnecting elements further connects to the second undulating element.

17. The device of claim 15, wherein the second undulating element extends between the first linear element and the first undulating element.

18. The device of claim 15, wherein the first linear element is located between the first and second undulating elements.

19. The device of claim 15, wherein the first undulating element comprises at least one curved portion, and wherein the second undulating element comprises at least one substantially straight portion extending at an angle from the first direction.

20. The device of claim 5, wherein the first undulating element comprises at least one substantially linear portion extending generally in the first direction.

21. The device of claim 5, wherein the first undulating element comprises at least one substantially linear portion extending at an angle from the first direction.

22. The device of claim 5, wherein the first undulating element comprises at least one curved portion.

23. A plasma display panel device, comprising:
an array of a plurality of discharge cells;
a plurality of discharge electrodes formed over the array; and
at least one of the discharge electrodes comprising a meshed network of conductive connections having a plurality of through openings; and
wherein the openings have two or more different shapes.

24. The device of claim 23, wherein the at least one discharge electrode is made of a substantially non-transparent material.

25. The device of claim 23, wherein a pair of discharge electrodes among the plurality of discharge electrodes extends over a single discharge cell.

26. The device of claim 25, wherein the pair of discharge electrodes located over a single discharge cell run substantially parallel to each other, and wherein one of the pair has a mirror image configuration of the other.

27. The device of claim 23, wherein the device does not have a separate bus electrode electrically connected to the at least one discharge electrode and having a lower electric resistance than the discharge electrode.

28. The device of claim 23, wherein the at least one discharge electrode is configured to facilitate spreading electrical discharge from a central portion of the discharge cell to a peripheral portions of the discharge cell.

29. The device of claim 23, wherein the conductive connections of the meshed network comprises a first linear element and a first undulating element, wherein the first linear element substantially generally in the first direction, wherein the first undulating element extends along the first linear element and comprising at least one portion undulating with reference to the first direction, and wherein the conductive connections further comprise a plurality of interconnecting elements interconnecting the first linear element and the first undulating element.

30. The device of claim 29, wherein at least one of the interconnecting elements extends substantially perpendicular to the first linear element.

31. The device of claim 29, wherein the conductive connections further comprise a second substantially linear element extending generally in the first direction.

32. The device of claim 31, wherein at least part of the plurality of interconnecting elements further connects to the second linear element.

33. The device of claim 31, wherein the first undulating element is located between the first and second linear elements.

34. The device of claim 31, wherein the second linear element is located between the first linear element and the first undulating element.

35. The device of claim 29, wherein the conductive connections further comprise a second undulating element extending along the first linear element and comprising at least one portion undulating with reference to the first direction.

36. The device of claim 35, wherein at least part of the interconnecting elements further connects to the second undulating element.

37. The device of claim 35, wherein the first undulating element is located between the first linear element and the second undulating element.

38. The device of claim 35, wherein the first linear element is located between the first and second undulating elements.

39. The device of claim 29, wherein the first undulating element comprises a plurality of substantially straight portions extending generally in the first direction.

40. The device of claim 29, wherein the first undulating element comprises a plurality of substantially straight portions extending with an angle from the first direction.

41. The device of claim 29, wherein the first undulating element comprises a plurality of curved portions.
